(19) United States
(12) Patent Application Publication
(10) Pub. No.: US 2010/0316318 A1
(43) Pub. Date: Dec. 16, 2010

(54) Outer Ring Seal for a Bearing and Method of Installing the Same

(75) Inventor: William Gregory Hewitt, Taylors, SC (US)

Correspondence Address: THOMPSON COBURN LLP, ONE US BANK PLAZA, SUITE 3500, ST LOUIS, MO, 63101, US

(73) Assignee: RELIANCE ELECTRIC TECHNOLOGIES, LLC, Greenville, SC (US)

(21) Appl. No.: 12/482,018

(22) Filed: Jun. 10, 2009

(51) Int. Cl. F16C 33/72; B21D 53/10

(52) U.S. Cl. 384/477; 29/898.11

(57) ABSTRACT

A bearing has an outer ring with an annular side face with an outer ring raceway on an inner peripheral surface of the outer ring and an interface formed on an outer peripheral surface at an axial end portion of the outer ring adjacent the annular side face. A compressible element is disposed at the interface. A seal carrier is deformingly connected to the outer ring with a portion of the seal carrier conforming to the interface with the compressible element disposed therebetween forming a seal between the outer ring and the portion of the seal carrier attached thereto.

### BACKGROUND

The disclosure relates to a roller bearing comprising an inner ring and an outer ring each having a race which together form a bearing space in which rolling elements are accommodated. The bearing space is sealed by means of a first seal fixed on the outer ring and a second seal fixed on the inner ring. Leakage from and contamination ingress into the bearing space between the outer ring and the first seal is prevented by a compressible element disposed between the first seal and the outer ring.

### BRIEF DESCRIPTION OF THE DRAWINGS

FIG. 1 is a sectional view through a portion of a bearing assembly illustrating the internal components of the bearing assembly and seals applied to the bearing assembly rings;

FIG. 2 is a detailed view of a portion of the assembly of FIG. 1, illustrating in greater detail the seals and their attachment to the bearing assembly rings;

FIG. 3 is a partial sectional view of an installation system for mounting a seal to an outer ring of the type shown in FIGS. 1 and 2;

FIG. 4 is a detailed view of a portion of the installation system of FIG. 3, prior to crimping of the seal on the outer ring;

FIG. 5 is a detailed view similar to that of FIG. 4 illustrating the components of FIG. 4 following the crimping operation; and

FIG. 6 is a flow chart outlining a series of operations for forming the outer ring of the bearing set.

### DETAILED DESCRIPTION OF SPECIFIC EMBODIMENTS

Turning now to the drawings, and referring first to FIG. 1, a bearing assembly 10 is illustrated in partial section. The bearing assembly 10 includes housing 12 in which a bearing set 14 is supported. The bearing set 14 is an antifriction bearing set, including an outer ring 16, an inner ring 18, and a series of bearing elements 20 interposed between the outer ring and the inner ring. Although a roller bearing is illustrated in FIG. 1, the techniques described below may be applied to roller bearings, as well as needle bearings, ball bearings, thrust bearings, journal bearings, and so forth.

In the embodiment illustrated in FIG. 1, seals are provided on either side of the bearing set to separate an internal volume in which the bearing elements are disposed from the surrounding environment. Such separation may be useful for maintaining lubricants, both liquid and gaseous, within the internal volume and for precluding the entry into the internal volume of debris, contaminants, moisture, and so forth from the surrounding environments. As shown in FIG. 1, a first seal 22 is supported on outer ring 16. The seal 22 includes a metallic support or seal carrier 24 which is annular in shape, and which supports an elastomeric wiper element 26 along a side face 27 of the outer ring. A second seal 28, in the form of a “finger,” is secured to the inner ring 18. The second seal 28, in the embodiment shown, forms a shield and interacts with the first seal elastomeric wiper element 26 in operation. In one application of the bearing set, the inner ring 18 will be caused to rotate with a supported element, such as a shaft (not shown) within the outer ring 16 in the housing 12. Thus, the second seal 28 secured to inner ring 18 will similarly rotate, while the first seal 22 and its supported elastomeric wiper element 26 will remain stationary. Accordingly, in the embodiment shown, the first seal elastomeric wiper element 26 rides against both the second seal 28 and against an outer peripheral region of the inner ring 18. Together the flinger and the first seal assembly form a labyrinth seal to prevent the ingress of materials and to the bearing space. The first seal elastomeric element may be formed from a black nitro rubber having a hardness of 60 to 70 Shore durometer. Other materials may also be used. While the first seal elastomeric element shown in the drawings has three wiper lips 29′ engaging the inner ring and a fourth wiper leg 29″ riding on an inner surface of the flinger, more or less wipers may be used depending upon the seal design. Other configurations of wiper elements, flingers, flinger wiper elements, may also be used depending upon the application and whether the outer ring rotates relative to a stationary inner ring or vice versa as shown in the drawings.

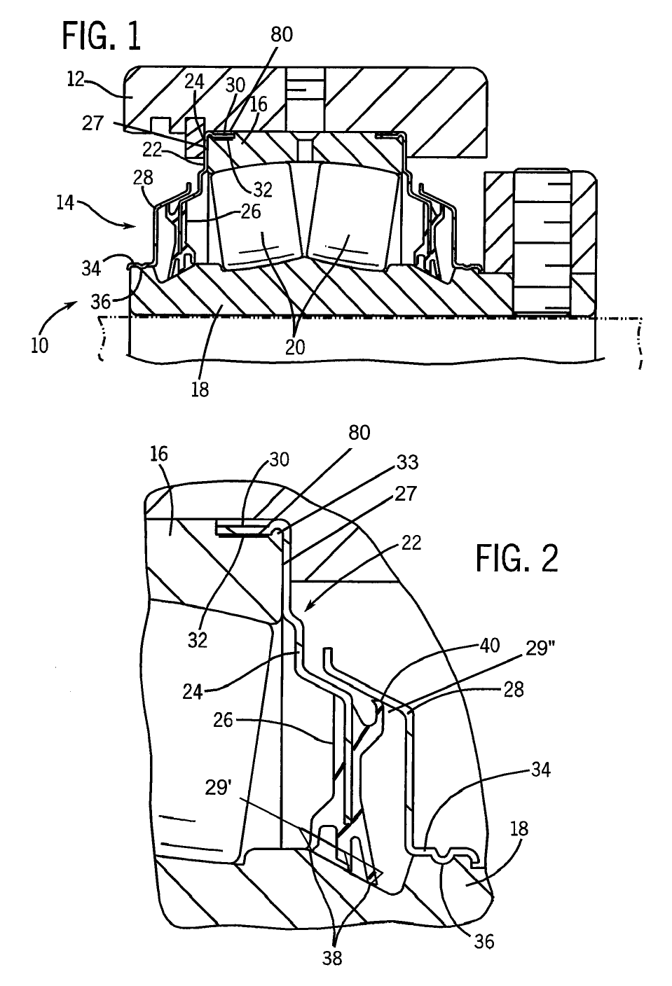

The various components and exemplary configuration of the seals shown in FIG. 1 are illustrated in somewhat greater detail in FIG. 2. As shown in FIG. 2, the first seal 22 is formed of the metallic support or seal carrier 24 which is generally annular in shape and which supports the annular elastomeric wiper element 26. In the illustrated embodiment, the elastomeric wiper element 26 has several lip projections 29′,29″ which ride against corresponding riding surfaces of the inner ring 18, and the second seal 28, respectively. The first and second seals 22,28 are secured to their respective outer and inner rings 16,18 by extension members 30,34, respectively. In particular, the outer ring seal 22 has an annular extension 30 which is deformed or crimped to the outer ring 16 against an interface surface 32. While the interface surface 32 shown in the drawings comprises an annular anchor groove about ring 16, the interface surface 32 may include dimples, ridges, and other such anti-rotation or rigidification features. As shown in the drawings, the outer ring may be formed with an anchor groove on an outer peripheral surface of the outer ring. Preferably, the anchor groove is positioned adjacent an axial portion of the outer ring adjacent a side face of the outer ring. As shown in more detail in FIG. 2, the anchor groove is formed with a lip 33 on the coterminous edge of the anchor groove and the outer ring side face 27, and the seal carrier extension, i.e., the portion of the seal carrier conforming to the outer ring, also conforms to the lip.

Similarly, the second seal 28 is secured to an interface surface 36 of the inner ring 18. The extension 34, again generally annular in shape, is deformed or crimped to conform to the interface surface 36, which may be similarly grooved or otherwise contoured. As mentioned above, the interface surface may include dimples, ridges, and other such anti-rotation or rigidification features, used for securement of the inner ring seal 28 to the inner ring 18. However, in the drawings, an annular groove is employed on the inner ring 18.

While FIG. 2 shows the configuration of the seals on only one axial side of the bearing unit, similar or identical sealing arrangements may be provided on both sides of a bearing assembly. In the illustrated embodiment, the seal assemblies are identical to one another both on the inner and outer rings. However, different seal assemblies may be provided on either side of the bearing set, or one side of the bearing set may include seals while the opposite side is partially or completely open.

As set forth above, the first and second seals of the bearing assembly are preferably installed by plastic deformation of a portion of the seal components. In other words, the seal components include a metallic member which is crimped directly to the interface surface of the receiving ring. Generally speaking, the seal carrier is formed from a low carbon steel material which exhibits sufficient malleability to allow it to be crimped or deformingly connected to the outer ring. Other materials, such as aluminum, bronze, plastics, may also be used to allow the seal carrier to be deformingly connected to the outer ring.

A method and apparatus for installing seals on a bearing, like the first and second seals discussed above, is disclosed in a co-pending, co-owned application, entitled, “Method and apparatus for installing bearing seals and bearing incorporating same,” (U.S. application Ser. No. 09/966,487), the disclosure of which is incorporated by reference herein. FIG. 3 illustrates an exemplary installation station 42 for securing a seal 22 to an outer ring 16 as described above. The system 42 illustrated in FIG. 3 is adapted for mounting in a press (not shown), such as a hydraulic press. The system includes a base or pot 44 closed at its lower end by a stop 46. The pot 44 is open at its upper end, and a tapered ring 48 is secured about the inner periphery of the upper end. A crimping collet 50 is positioned within the pot 44 and bears against the tapered ring 48.

The crimping collet 50 is a single piece, metallic collet designed to contract upon entry into the tapered ring and pot, and to be released or expand for removal of the outer ring from the tool as described below. Accordingly, the crimping collet 50 includes a series of crimping sections 52 designed to be forced radially inwardly by the tapered ring during the crimping operation. Each crimping section 52 is formed at the end an elastically deformable leg 54. Slots 56 are provided between the legs 54 to facilitate the radial contraction of the collet during use.

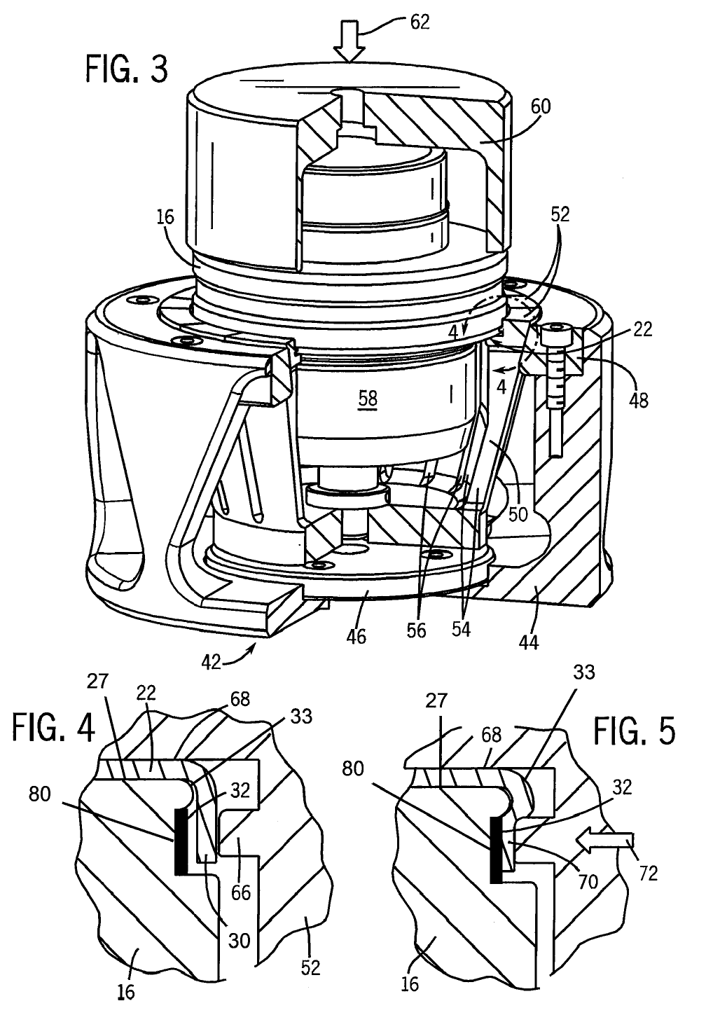

A seal support cup 58 is positioned within the collet 50 for receiving the outer ring seal carrier 22. The seal support cup 58 thus receives and centers the outer ring seal prior to the crimping operation. An upper cup 60 serves to exert force against the bearing outer ring when positioned in the installation system. For attachment of the outer ring seal to the outer ring, force is applied to the upper cup 60, as indicated by arrow 62 in FIG. 3. With the outer ring 16 in place within the seal 22, and with the seal centered by the seal support cup 58, the force applied to the outer ring urges the collet 50 downwardly, thereby forcing the radial contraction of the crimping section 52 by interaction with the tapered ring 48. As best shown in FIG. 4, prior to crimping, the outer ring 16 is positioned such that the uncrimped extension 30 of the first seal 22 lies in facing relation to the interface surface 32. A projection 66 of each crimping section 52 is positioned adjacent to the extension 30 of the seal. A lower support surface 68 supports the seal 22 and seal carrier 27 and ring 16. Upon downward movement of the ring and seal, and radial contraction of the collet crimping sections against the tapered ring, the projections 66 are forced inwardly to deform the extension 30, as indicated at reference numeral 70 in FIG. 5. The crimping operation is stopped upon full engagement of the crimping section and full deformation and securement of the seal as indicated by arrow 72 in FIG. 5. Thereafter, the force on the ring is released and the seal and ring are allowed to move upwardly in the view of FIG. 3, releasing the collet and freeing the outer ring and seal for removal from the installation system. Where desired, a similar seal may be applied subsequently to an opposite side of the outer ring in the same or different installation system. A similar device (not shown) may be used for applying the second seal carrier 28 or flinger to the inner ring of the bearing set.

As shown in the drawings, the first seal extension 30, i.e., the portion of the seal carrier conforming to the anchor groove, the lip, and the side face of the outer ring, also forms a seal between the seal carrier and outer ring. The seal formed between the portion of the seal carrier conforming to the anchor groove, the lip, and the side face of the outer ring elements prevents the ingress of contaminants into the bearing space and the leakage of lubricant from the bearing space in the interface between the outer ring and the seal carrier. To enhance the seal formed between the seal carrier and the outer ring, a compressible element 80 is disposed between the interface 32 and the portion of the seal carrier deformingly connected to the outer ring. The compressible element may be placed in the outer ring interface, on the extension of the seal carrier to be deformingly connected to the outer ring interface, or on both surfaces prior to operations to deformingly connect the seal carrier to the outer ring. Preferably, the compressible element comprises a silicone material. Various rubber materials may also be used. The compressible element reduces the amount of clamping force needed to deformingly connect the seal carrier to the outer ring while still providing sufficient frictional force between the interface 32 and the seal carrier 26 such that the seal 22 will not spin when subjected to torque from the wiper element legs 29′, 29″ bearing on the spinning inner ring 18. By using the compressible element, the clamping force may be reduced, thereby minimizing potential deformation of the outer ring and outer ring raceway while still forming a sufficiently rigid connection and seal between the seal carrier and outer ring.

Generally speaking, high clamping forces are required to deformingly connect the seal carrier to the outer ring to form the seal and to ensure the seal carrier does not rotate relative to the outer ring during operation of the bearing. Sometimes, the high clamping forces permanently deform the outer ring, thus leading to increased bearing temperatures and a reduction in bearing life. The use of a compressible element 80 in the interface 32 reduces the clamping forces required to deformingly connect the seal carrier to the outer ring with a seal therebetween sufficient to prevent leakage from the bearing space and with sufficient frictional force to resist torque applied to the seal carrier through rotation of the shaft.

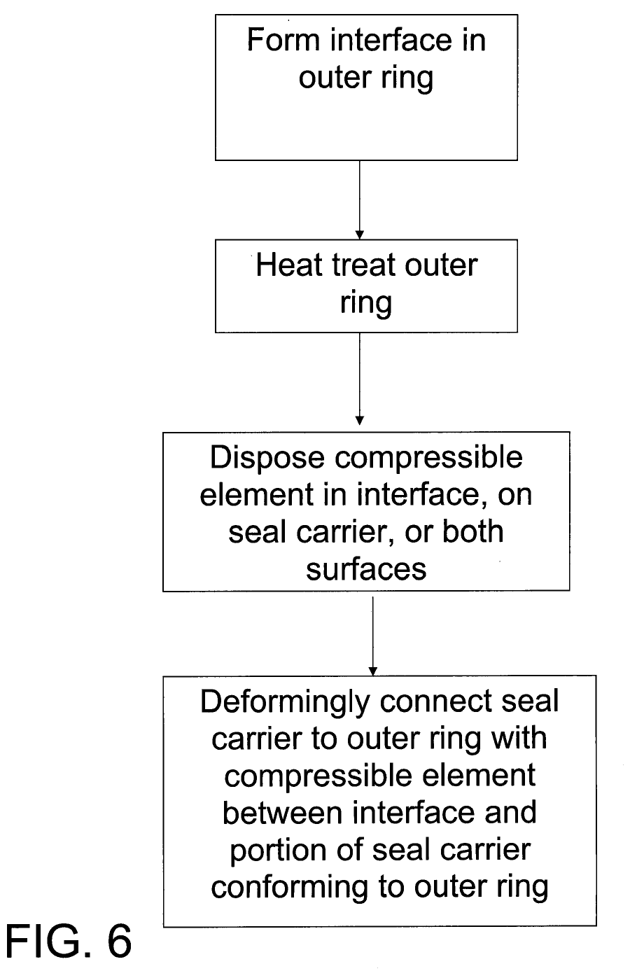

Additionally, the use of a compressible element 80 between the extension 30 and the interface 32 accommodates for any deformation or distortion of the interface, for instance, from heat treating of the outer ring. In one method of bearing manufacture as shown in the flow chart of FIG. 6, the interface 32 comprising an anchor groove and lip may be machined in the outer ring, and then the outer ring may be heat treated. Often, the heat treating of the outer ring causes distortion of the anchor groove and lip. When the anchor groove is highly distorted, high clamping forces are generally required to secure the seal carrier to the outer ring with a seal therebetween sufficient to prevent leakage from the bearing space. As mentioned before, this excessive clamping force sometimes deforms the outer ring leading to increased bearing temperatures and a reduction in bearing life. The use of a compressible element 80 in the interface 32, i.e., anchor groove, accommodates for any distortion of the anchor groove from the heat treat process, allowing the use of lower clamping forces to deformingly connect the seal carrier to the outer ring, thus reducing potential distortion of the outer ring and outer ring raceway while providing for a leak-proof seal between the outer ring and seal carrier.

Accordingly, the methods disclosed herein may be used in connection with any thin walled seal with a seal carrier crimped thereto, thus allowing the seal carrier to be deformingly connected to the thin walled section using relatively lower clamping forces and, thus, contributing less to potential deformation of the thin walled section. This application is particularly suited for roller bearings units where the overall axial width of the outer ring is controlled. Providing the outer ring with an interface, such as an anchor groove, and deformingly connecting the seal carrier to the interface and extending the seal carrier along an axial side face of the outer ring allows the overall axial width of the outer ring to be less than alternative designs involving a seal carrier extending from the inner diameter surface of the outer ring. For instance, forming a groove in the inner diameter surface of the outer ring and extending the seal carrier from the groove toward the inner ring generally requires the outer ring to have an increased axial width to accommodate the groove and the lip. On the other hand, forming the interface on the outer peripheral surface of the outer ring and extending the seal carrier therefrom allows for an overall, more compact bearing design.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limited as to the scope of the invention which is to be given the full breadth of the appended claims and any and all equivalents thereof.

What is claimed is:

1. A bearing comprising:
an outer ring having a generally annular side face with an outer ring raceway on an inner peripheral surface of the outer ring, and an interface formed on an outer peripheral surface at an axial end portion of the outer ring adjacent the annular side face;
a compressible element disposed at the interface;
an inner ring having an inner ring raceway formed on an outer peripheral surface thereof;
a plurality of rotational elements rotatably positioned between the outer ring raceway and the inner ring raceway; and
a seal carrier extending from the outer ring toward the inner ring, the seal carrier deformingly connected to the outer ring with a portion of the seal carrier conforming to the interface with the compressible element disposed therebetween forming a rigid connection and seal between the outer ring and the portion of the seal carrier attached thereto.

2. The bearing of claim 1 wherein the interface comprises a groove.

3. The bearing of claim 2 wherein the coterminous edge between the outer ring side face and the groove includes a lip and the portion of the seal carrier deformingly connected to the outer ring conforms to the lip.

4. The bearing of claim 1 wherein the compressible element comprises a silicone material.

5. The bearing of claim 1 wherein the seal carrier abuts the outer ring side face.

6. A method comprising:
providing an outer ring having a generally annular side face with an outer ring raceway on an inner peripheral surface of the outer ring, and an interface formed on an outer peripheral surface at an axial end portion of the outer ring adjacent the annular side face;
disposing a compressible element at the interface;
providing an inner ring having an inner ring raceway formed on an outer peripheral surface thereof;
disposing a plurality of rotational elements between the outer ring raceway and the inner ring raceway; and
deformingly connecting a seal carrier to the outer ring in a manner such that a portion of the seal carrier conforms to the interface with the compressible element disposed therebetween to form a rigid connection and seal between the outer ring and the portion of the seal carrier attached thereto.

7. The bearing of claim 6 wherein the interface comprises a groove.

8. The method of claim 7, wherein the coterminous edge between the outer ring side face and the groove includes a lip; and the step of deformingly connecting the portion of the seal carrier to the outer ring includes conforming the seal carrier to the lip.

9. The method of claim 6, wherein the compressible element comprises a silicone material.

10. The method of claim 6, wherein the seal carrier abuts the outer ring side face.

11. The method of claim 6, further comprising heat treating the outer ring after forming the interface in the outer ring.

12. The method of claim 12, further comprising disposing the compressible element between the portion of the seal carrier deformingly connected to the outer ring and the interface in a manner to accommodate any distortion of the interface caused by heat treating the outer ring.
